(19) United States
(12) Patent Application Publication
(10) Pub. No.: US 2006/0060341 A1
(43) Pub. Date: Mar. 23, 2006

(54) Air conditioner for vehicle use and door device

(75) Inventor: Hiromitsu Maehata, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/220,348

(22) Filed: Sep. 6, 2005

(30) Foreign Application Priority Data
Sep. 8, 2004 (JP) 2004-261099
Jul. 1, 2005 (JP) 2005-194183

(51) Int. Cl. B60H 3/00; B60H 1/00

(52) U.S. Cl. 165/202; 165/42

(57) ABSTRACT

An air conditioner for vehicle use of the present invention comprises: an air conditioning case 1; a heat exchanger H for heating; a rotary door 2 having an axial center portion 21, a door portion 20 and a support portion 22; and a reheat preventing door 3 connected to the rotary door 2 via a hinge portion 4. In the air conditioner for vehicle use of the present invention, since the door portion 20 of the rotary door 2 and the reheat preventing door 3 are arranged close to each other, a dead space formed between the door portion 20 and the reheat preventing door 3 can be reduced. Accordingly, it is possible to reduce generation of noise.

### BACKGROUND OF THE INVENTION

1. Field of the Invention

The present invention relates to a door device for changing over an air passage. More particularly, the present invention relates to an air conditioner for vehicle use having a reheat preventing door which controls the volume of air flowing in a heat exchanger for heating by the air cooled in an evaporator.

2. Description of the Related Art

An air conditioner for vehicle use is provided in a vehicle, by which the temperature and humidity of air blown into a vehicle interior can be controlled. In the air conditioner for vehicle use, air, which has been cooled by an evaporator, is heated by a heater so that the temperature of the conditioned air can be adjusted at a predetermined value. The thus conditioned air is blown out into the vehicle interior. For example, an air conditioner for vehicle use includes: an evaporator for cooling the introduced air; a heat exchanger for heating used for heating a cold air blast; a bypass passage which bypasses the heat exchanger for heating; and an air mixing door arranged in the opening portions of a passage to the heat exchanger for heating and a bypass passage, wherein the reheating of the cold air blast is adjusted by adjusting the degree of opening of the opening portions of both passages by changing over the air mixing door. A hot air blast, which has been heated by the heat exchanger for heating, and a cold air blast, which has passed in the bypass passage, are mixed with each other downstream. In this way, a conditioned air blast can be obtained. This conditioned air blast is blown into the vehicle interior from various blowout openings which open into the vehicle interior.

One type of air mixing door for adjusting the ratio of the cold air blast to the hot air blast in the air conditioner for vehicle use is a rotary door. The rotary door is formed into a shape shown in the perspective view of FIG. 2. The rotary door includes: a door portion 20 which is formed into a substantially arcuate shape swelling toward the upstream side of the air flow; an axial center portion 21 provided at the central axis portion of the substantially arcuate face of the door portion 20; and support portions 22, 22 provided at both end portions in the axial direction of the door portion 20, for connecting the door portion 20 with the axial center portion 21, wherein the door portion 20 adjusts the degree of opening of the opening portion of the passage from the heat exchanger for heating and the degree of opening of the bypass passage when the axial center portion 21 is rotated.

The rotary door controls flow rates of the cold air blast and the hot air blast in the opening portion of the bypass passage and the downstream portion of the heat exchanger for heating. That is, when MAX COOL, in which the temperature of the conditioned air is the coolest, is selected, the passage on the downstream side of the heat exchanger for heating is sealed by the door portion.

However, when MAX COOL is selected, a portion of the cold air blast sent from the evaporator proceeds on a surface of the heat exchanger for heating and then passes in the bypass passage. At this time, the cold air blast, which has proceeded on the surface of the heat exchanger for heating, is heated by the heat exchanger for heating. As a result, a problem is caused in which the temperature of the conditioned air is raised to a value higher than a desired temperature.

In order to solve the above problem, an air conditioner for vehicle use is provided in which a reheat preventing door for controlling the volume of the cold air blast flowing in the heat exchanger for heating is provided on the upstream side of the heat exchanger for heating. The structure of this air conditioner for vehicle use is shown in FIGS. 13 and 14. The reheat preventing door 3 includes a plate-shaped seal portion 32 and a rotating shaft 33 for rotating the seal portion 32. This reheat preventing door 3 is pivotally arranged in the upstream portion of the heat exchanger H for heating. The reheat preventing door 3 is rotated via the rotating shaft 33, so that the flow rate of the cold air blast sent to the heat exchanger H for heating can be controlled. The axial center portion 21 and the rotating shaft 33 are connected to each other by the link mechanism 34 so that the action of the reheat preventing door 3 can be linked with the action of the rotary door 2. Therefore, in the conventional air conditioner for vehicle use having the reheat preventing door 3, the structure becomes complicated because of the link mechanism 34. Further, the number of parts is increased and the manufacturing cost is raised.

The specification of French Patent Application Open to Public Inspection No. 2761011 discloses an air conditioner for vehicle use including: an air mixing door 6 having a rotary shaft and a plate-shaped door portion extending in the radial direction from the rotary shaft; and a plate-shaped reheat preventing door 3 arranged in one end portion in the radial direction of the air mixing door 6 via the hinge portion 7 and connected to the end portion. The arrangement of the air conditioner for vehicle use disclosed in the above French Patent Document is shown in FIG. 12. This air conditioner for vehicle use described in the Patent Document is composed as follows. When an angle formed between the air mixing door 6 and the reheat preventing door 3 is represented by θ, a force contributing to the driving of the reheat preventing door 3 is sin θ times as high as the force given to the end portion of the air mixing door 6. Therefore, if the angle (θ) formed between the air mixing door 6 and the reheat preventing door 3 is made to be extremely small, a very high intensity of torque is required for the rotary shaft of the air mixing door 6. For this reason, it is impossible to reduce the angle (θ), which is formed between the air mixing door 6 and the reheat preventing door 3, to be smaller than a predetermined angle. As a result, according to the air conditioner for vehicle use described in the above Patent Document, it is impossible to reduce the angle (θ), which is formed between the air mixing door 6 and the reheat preventing door 3, to be smaller than a predetermined angle, and dead space D, in which the conditioned air blast is difficult to flow, is formed.

In this air conditioner for vehicle use, the rotary shaft 60 of the air mixing door 6, the door portion 61 and the hinge portion 7 are located on one plane continuous to each other. In the air conditioner for vehicle use in which the air mixing door 6 and the reheat preventing door 3 are connected to each other by the hinge portion 7, dead space D is formed between the door portion 61 of the air mixing door 6 and the reheat preventing door 3. When dead space D is formed as described above, air flowing in the air passage stays in dead space D and noise is generated. In order to reduce the generation of dead space D in the structure of the above French Patent Document, a method may be employed in which the angle θ formed between the door portion 61 and the reheat preventing door 3 is reduced at the time of MAX HOT. However, according to this method, the rotary angle of the air mixing door 6 between MAX HOT and MAX COOL is increased, and the size of the air conditioner is extended.

### SUMMARY OF THE INVENTION

The present invention has been accomplished in view of the above circumstances. It is a task of the present invention to provide an air conditioner for vehicle use characterized in that the reheat preventing effect can be provided at a low manufacturing cost and the dead space is small, that is, no noise is generated, without increasing the rotary angle.

In order to solve the above problems, the present inventors conducted investigations into the reheat preventing door of an air conditioner for vehicle use. As a result of their investigations, the present invention has been accomplished.

The present invention provide an air conditioner for vehicle use comprising: an air conditioning case for forming an air passage; a heat exchanger for heating arranged in the air passage; a rotary door including an axial center portion rotating round a rotary center, further including a door portion arranged at a position distant from the axial center by a distance and displaced in the circumferential direction according to the rotation of the axial center, furthermore including a support portion for connecting the axial center with the door portion, wherein the door portion is displaced between a position, at which the door portion completely closes the heat exchanger for heating at the time of MAX COOL, and a position, at which the door portion completely opens the heat exchanger for heating at the time of MAX HOT, on one of the upstream side and the downstream side of the heat exchanger for heating, and a reheat preventing door connected to the rotary door via a hinge portion so that the reheat preventing door can be located outside the door portion in the radial direction, displaced according to the rotation of the rotary door, wherein the reheat preventing door is displaced between a position, at which the reheat preventing door completely closes the heat exchanger for heating at the time of MAX COOL, and a position, at which the reheat preventing door completely opens the heat exchanger for heating at the time of MAX HOT, on the other of the upstream side and the downstream side of the heat exchanger for heating.

In the air conditioner for vehicle use of the present invention, the door portion and the axial center portion are arranged via the support portion being distant from each other, and the reheat preventing door is connected to the door portion via the hinge portion. Since the door portion and the axial center portion are arranged being distant from each other, the reheat preventing door and the door portion of the rotary door come close to each other without depending upon the rotary angle of the axial center portion of the rotary door. Therefore, the dead space formed between the reheat preventing door and the door portion of the rotary door can be reduced. Accordingly, since the dead space formed between the door portion of the rotary door and the reheat preventing door can be reduced, generation of noise can be decreased.

The present invention provides an air conditioner for vehicle use comprising: an air conditioning case for forming an air passage; an evaporator arranged in the air passage; a heat exchanger for heating arranged in the air passage on the downstream side of the evaporator; a reheat preventing door arranged in the air passage between the evaporator and the heat exchanger for heating, for partitioning the air passage; and a rotary door arranged in the air passage, for adjusting the ratio of a volume of air sent from the evaporator and making a detour round the heat exchanger for heating to a volume of air passing in the heat exchanger for heating, a door portion of the rotary door being formed into a substantially arcuate shape swelling toward the upstream side of the air passage, wherein the reheat preventing door is arranged so that it can be reciprocated in a direction oblique to the flow direction of air flowing in the air passage, and an end portion of the reheat preventing door is connected to a portion close to an end portion in the circumferential direction of the door portion of the rotary door, the end portion being distant from the heat exchanger for heating, by the hinge portion.

The present invention provides a door device comprising: a rotary door including an axial center portion held by a case composing an air passage, further including a support member integrally rotated with the axial center portion and furthermore including a door portion supported by the support member being connected to it, rotated together with the axial center portion while the door portion is drawing a circular locus concentrically with the axial center portion; and a driven door, one end of which is connected to the door portion being capable of oscillating, the other end of which slides along a sliding portion provided in the case.

The air conditioner for vehicle use of the present invention includes a reheat preventing door on the upstream side of the heat exchanger for heating. Therefore, a cold air blast flowing on a surface of the heat exchanger for heating arranged on the upstream side does not flow onto the bypass passage side.

In the air conditioner for vehicle use of the present invention, the reheat preventing door is connected to an end portion of the door portion of the rotary door. Therefore, it is not necessary to use a link mechanism. Accordingly, the air conditioner for vehicle use of the present invention can provide a reheat preventing effect at a low manufacturing cost. Further, in accordance with the rotation of the rotary door, the reheat preventing door is reciprocated. Therefore, it is possible to simply obtain a desired conditioned air blast.

In the air conditioner for vehicle use of the present invention, the reheat preventing door is connected to the door portion of the rotary door. Therefore, when a smaller angle of the angles formed between the door portion of the rotary door and the reheat preventing door is represented by δ, a force contributing to the drive of the reheat preventing door is cos δ times as high as the force given to the end portion of the air mixing door. Therefore, even when the angle (δ) formed between the air mixing door and the reheat preventing door is extremely reduced, there is no possibility of a very high intensity of torque being required for the rotary shaft of the rotary door. As a result, it is possible to reduce the angle (δ) formed between the rotary door and the reheat preventing door, and it becomes possible to reduce a space formed between the door portion of the rotary door and the reheat preventing door. For the above reasons, there is no possibility of a dead space, in which it is difficult for a conditioned air blast to flow, being formed like in the air conditioner for vehicle use described in the above Patent Document.

Since the door device of the present invention includes a driven door which is driven in accordance with the rotation of the rotary door, a passage of the fluid flowing in the case can be selected.

The present invention may be more fully understood from the description of preferred embodiments of the invention, as set forth below, together with the accompanying drawings.

### BRIEF DESCRIPTION OF THE DRAWINGS

In the drawings:

FIG. 1 is a view showing an arrangement of an air conditioner for vehicle use of an embodiment;

FIG. 2 is a perspective view showing a rotary door of an air conditioner for vehicle use of an embodiment;

FIG. 3 is a view showing an arrangement of a periphery of a hinge portion of an air conditioner for vehicle use of an embodiment;

FIG. 4 is a view showing an arrangement of an air conditioner for vehicle use of an embodiment;

FIG. 5 is a view showing an arrangement of a periphery of a hinge portion of an air conditioner for vehicle use of the first variation;

FIG. 6 is a view showing an arrangement of a periphery of a hinge portion of an air conditioner for vehicle use of the second variation;

FIG. 7 is a view showing an arrangement of a periphery of a hinge portion of an air conditioner for vehicle use of the third variation;

FIG. 8 is a view showing an arrangement of a periphery of a hinge portion of an air conditioner for vehicle use of the fourth variation;

FIG. 9 is a perspective view of a rotary door of another embodiment;

FIG. 10 is a perspective view of a rotary door of still another embodiment;

FIG. 11 is a perspective view of a rotary door of still another embodiment;

FIG. 12 is a view showing a structure of a conventional air conditioner for vehicle use;

FIG. 13 is a view showing a structure of a conventional air conditioner for vehicle use; and

FIG. 14 is a view showing a structure of a conventional air conditioner for vehicle use.

### DESCRIPTION OF THE PREFERRED EMBODIMENTS

The present invention will be explained below on the basis of an embodiment.

As an embodiment of the present invention, an air conditioner for vehicle use was manufactured.

### Embodiment

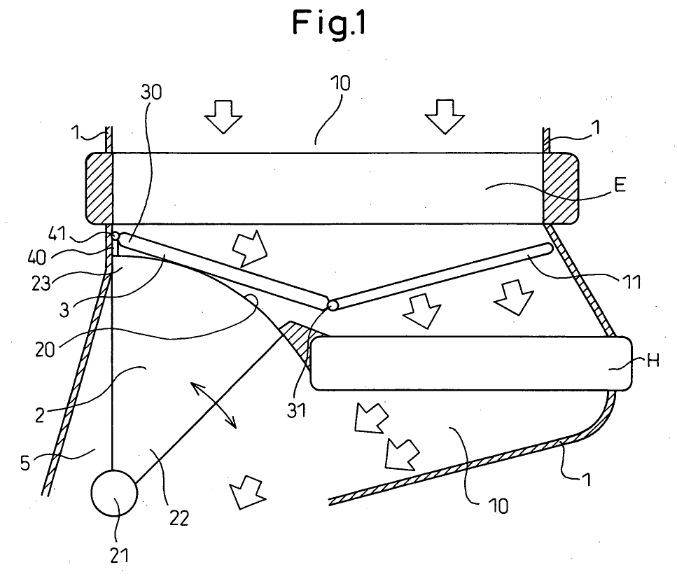

An air conditioner for vehicle use of this embodiment comprises: an air conditioning case, which corresponds to the case described in claim 9; an evaporator E; a heater core H, which corresponds to the heat exchanger for heating described in claims; a reheat preventing door 3, which corresponds to the driven door described in claim 9; and a rotary door 2, which corresponds to the rotary door described in claim 9. The main structure of the air conditioner for vehicle use of this embodiment is shown in FIG. 1.

The air conditioning case 1 constitutes an air passage 10, which corresponds to the passage described in claim 9. Evaporator E, heater core H, the reheat preventing door 3 and the rotary door 2 are arranged and held in the air passage 10 formed in the air conditioning case 1.

Evaporator E is arranged in the air passage 10 and cools air flowing in the air passage 10.

Heater core H is arranged in the air passage 10 on the downstream side of evaporator E and heats a cold air blast which has passed through evaporator E.

In the air conditioner for vehicle use of this embodiment, the bypass passage 5 is provided in which a cold air blast cooled by evaporator E flows making a detour round heater core H and flows. A cold air blast, which has passed through the bypass passage 5, and a hot air blast, which has been heated by heater core H, are mixed with each other on the downstream side of the bypass passage, so that the temperature of the conditioned air blast can be adjusted.

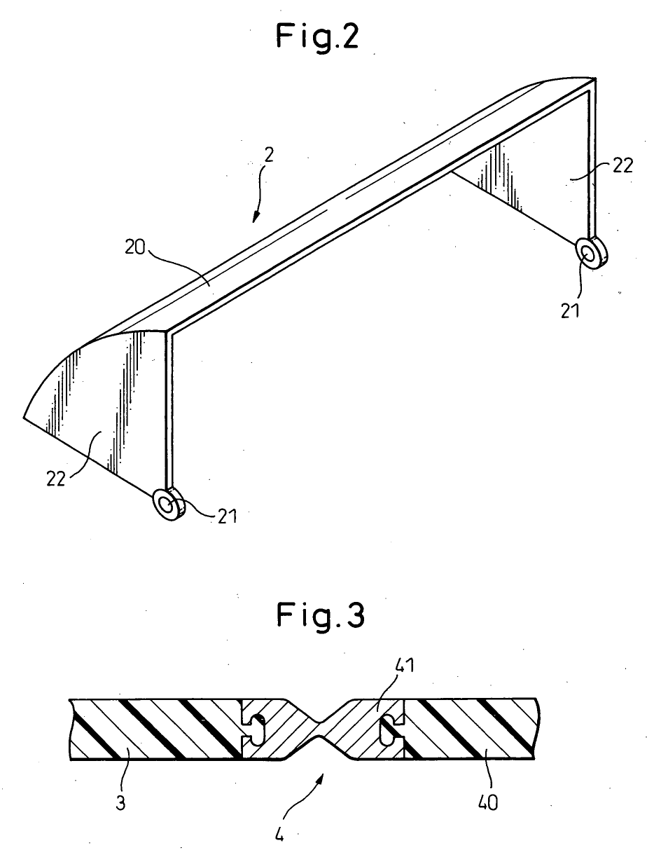

In the opening portion of the bypass passage 5, the rotary door 2 having a door portion 20, the shape of which is formed into an arcuate face swelling toward the upstream side of the air passage 10, is arranged. The rotary door 2 includes: an axial center portion 21 rotating along the center axis portion on the arcuate face of the door portion 20; and a plate-shaped support portion 22 connecting the door portion 20 with the axial center portion 21. To be specific, the door portion 20 has a shape which is formed when a portion of a cylinder is cut out in the circumferential direction. The support portion 22 is formed into a substantial sector-shape which is connected to both end portions in the axial direction of the door portion 20. The axial center portion 21 is formed in such a manner that the rotary center of the axial center portion 21 is located at the center of the arc of the door portion 20 and also at the center of the substantial sector-shape of the support portion 22. When the axial center portion 21 is rotated, the door potion 20 of the rotary door 2 adjusts the degree of opening of the bypass passage 5. The rotary door 2 can also adjust the degree of opening of the air passage in which a hot air blast heated by heater core H flows. That is, on the downstream side of heater core H, the rotary door 2 is displaced between a position, at which the air passage in which a hot air blast heated by heater core H flows is completely opened, and a position, at which the air passage in which a hot air blast heated by heater core H flows is completely closed. Further, since the support portion 22 is formed in a plate-shape, the support portion 22 does not obstruct an air current which flows on the axial center side of the door portion 20 of the rotary door 2. FIG. 2 is a perspective view of the rotary door 2 of this embodiment. In this connection, in FIG. 2, the hinge portion for connecting the rotary door 2 with the reheat preventing door 3 is omitted.

According to the rotation of the rotary door 2, the reheat preventing door 3 is displaced and obstructs at least a portion of the air passage 10, in which air passing through heater core H flows in the upstream of heater core H, and also obstructs at least a portion of the bypass passage 5 in which air making a detour round heater core H flows. That is, the reheat preventing door 3 is displaced being capable of reciprocating between a position, at which the air passage of air flowing to heater core H is completely opened on the upstream side of heater core, and a position, at which the air passage of air flowing to heater core H is completely closed on the upstream side of heater core. The reheat preventing door 3 controls the flow rate of the cold air blast flowing in heater core H. The reheat preventing door 3 is formed in a plate-shape arranged in the air passage.

The reheat preventing door 3 is connected to the rotary door 2 via the hinge portion 4 so that the reheat preventing door 3 can be located outside the door portion 20 in the radial direction. The hinge portion 4 connects one end portion of the reheat preventing door 3 in the displacing direction in the air passage 10 with the rotary door.

FIG. 3 is a sectional view of the hinge portion 4 for connecting the rotary door 2 with the reheat preventing door 3. As shown in FIG. 3, the hinge portion 4 includes: a protruding portion 40 protruding from an outer circumferential face of the door portion 20 of the rotary door 2;.and an oscillating center portion 41 provided at a forward end portion of the protruding portion 40. The protruding portion 40 is formed being protruded outside in the radial direction in the end portion 22 in the circumferential direction of the door portion 20 of the rotary door 2. This end portion 22 is distant from heater core H. The protruding portion 40 is made of the same resin as that of the rotary door 2 and integrally formed into one body. The oscillating center portion 41 is composed of a thin-walled portion made of resin elastomer, the elasticity of which is different from that of the resin composing the protruding portion 40. The thin-walled portion of the hinge portion 4 is formed into a shape in which a substantially V-shaped notch is formed on both sides of the plate-shape. The oscillating center portion 41 of the hinge portion 4 was formed by means of two-color forming of the resin elastomer composing the rotary door 2 and the reheat preventing door 3 and the resin elastomer composing the hinge portion 4. When the hinge portion 4 is oscillated round the oscillating center portion 41, an angle formed between the direction, in which the protruding portion 40 is extending, and the direction, in which the reheat preventing door 3 is spreading, can be freely changed. That is, the reheat preventing door 3 is connected to the rotary door 2 under the condition that the reheat preventing door 3 can be oscillated.

At an end portion of the reheat preventing door 3, which is an end portion in the direction of the displacement in the air passage 10 and which is not connected to the hinge portion 4, the guide protruding portion 31 is provided which protrudes in the axial direction (the direction perpendicular to the surface of FIG. 1) of the rotary shaft of the axial center portion 21 of the rotary door 2. This guide protruding portion 31 of the reheat preventing door 3 is inserted into the recess-shaped guide groove 11, which corresponds to the sliding portion described in claim 9, for guiding the displacement of the reheat preventing door 3, and which is formed on the inner surface of the air conditioning case 1 to define the air passage 10.

The action of the air conditioner for vehicle use of this embodiment will be explained below.

In the air conditioner for vehicle use of this embodiment, air is introduced into the air conditioning case 1 by an air blast means not shown in the drawing, and the thus introduced air is sent to evaporator E by the air passage 10. The air introduced into the air passage 10 is cooled by evaporator E and then heated by heater core H. The air cooled by evaporator E can be made to flow into the bypass passage 5. The cold air blast introduced into the bypass passage 5 is sent to the air passage 10 as it is. Then, the hot air blast, which has been heated by heater core H, and the cold air blast, which has passed through the bypass passage, are mixed with each other. In this way, a blast of the conditioned air, which has been previously set, can be obtained and made to blow out from a blowout opening (not shown) into a vehicle interior.

The air conditioner for vehicle use of this embodiment is in the state shown in FIG. 1. When the bypass passage 5 is obstructed by the rotary door 2, that is, when the air conditioner is set at MAX HOT, the end portion 23 in the circumferential direction of the door portion 20 of the rotary door 2, that is, the end portion 23 which is distant from the heater core is located at the most distant position from heater core H. The reheat preventing door 3, which is connected to the rotary door 2 via the protruding portion 40 and the hinge portion 4 having the oscillating center portion 41, is located on the upstream side of the door portion 20 of the rotary door 2. Under the above condition, the air passage 10 communicated with heater core H is not obstructed, and a blast of cold air flows to heater core H. Therefore, all of the blast of cold air sent from evaporator E flows into the air passage 10 and heated by heater core H arranged in the air passage 10. In this way, a blast of hot air is sent from the blowout opening into the vehicle interior.

When the axial center portion 21 of the rotary door 2 is rotated by a means not shown in the drawing, the door portion 20 is rotated in the circumferential direction according to the rotation of the axial center portion 21, and the bypass opening 5 is opened. At this time, the door portion 20 of the rotary door 2 obstructs a portion of the air passage 10 on the downstream side of heater core H. Due to the foregoing, a blast of cold air flows not only in heater core H but also in the bypass passage 5. Therefore, the flow rate of the hot air blast heated by heater core H is restricted. Accordingly, the temperature of the conditioned air, which blows out from the blowout opening, can be adjusted.

When the rotary door 2 is rotated, the protruding portion 40 protruding from the door portion 20 is displaced. According to the displacement of the protruding portion 40, the oscillating center portion 41 and the base end portion 30 of the reheat preventing door 3 connected to the oscillating center portion 41 are also displaced. The displacement of the protruding portion 40 caused by the rotation of the rotary door 2 is a displacement in the direction in which the protruding portion 40 comes close to heater core H. Due to this displacement, the protruding portion 40 pushes the base end portion 30 of the reheat preventing door 3. A pushing force for pushing the reheat preventing door 3 in the forward end direction is exerted by the base end portion 30. Therefore, the reheat preventing door 3 is slid. At this time, the guide protruding portion 31 provided at the forward end portion is guided by the guide groove 11. When the reheat preventing door 3 is slid, the degree of opening of the air passage 10 to heater core H is reduced, and the volume of air sent to heater core H is decreased.

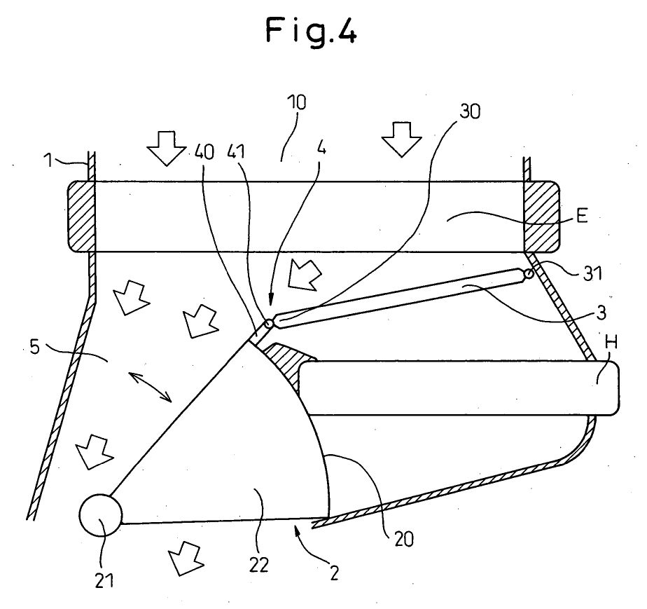

When the rotary door 2 is further rotated, the rotary door 2 is put into the state shown in FIG. 4. In this state, the opening portion of the bypass passage 5 is completely opened, that is, the air conditioner is set at MAX COOL. In this state, the door portion 20 of the rotary door 2 obstructs the air passage 10 on the downstream side of heater core H. The end portion 23, in which the protruding portion 40 of the rotary door 2 is provided, is located at the closest position to heater core H. At this time, the reheat preventing door 3, which is connected to the rotary door 2 via the hinge portion 4, obstructs the air passage 10 on the upstream side of heater core H. In this state, the air passage 10 communicated with heater core H is obstructed. Therefore, a cold air blast flows into the bypass passage 5. Accordingly, all of the cold air blast sent from evaporator E flows into the bypass passage 5. This cold air blast becomes a blast of the conditioned air.

Since the reheat preventing door 3 is provided in the air conditioner for vehicle use of this embodiment, a blast of cold air does not flow on the surface of heater core H at the time of MAX COOL. Accordingly, there is no possibility of a blast of cold air, which is heated by heater core H when it passes in the periphery of heater core H, being generated. Therefore, it is possible to obtain a blast of the desired conditioned air.

In the air conditioner for vehicle use of this embodiment, the reheat preventing door 3 is connected to the door portion 20 of the rotary door 2 via the hinge portion 4. Further, the door portion 20 of the rotary door 2 is arranged at a position distant from the rotary shaft (the axial center portion 21). Since the reheat preventing door 3 and the door portion 20 of the rotary door 2 are connected to each other via the hinge portion 4, they are close to each other. That is, the reheat preventing door 3 and the door portion 20 of the rotary door 2 are closely arranged irrespective of the rotary angle of the rotary shaft of the rotary door 2. Therefore, a dead space, which is formed between the reheat preventing door 3 and the door portion 20 of the rotary door 2 in the state shown in FIG. 1, can be reduced. Thus, according to the air conditioner for vehicle use of this embodiment, since the dead space, which is formed between the reheat preventing door 3 and the door portion 20 of the rotary door 2 can be reduced, generation of noise can be decreased.

In the air conditioner for vehicle use of the present invention, the reheat preventing door 3 is connected to the door portion 20 of the rotary door 2. Therefore, when a smaller angle of the angles formed between the door portion 20 of the rotary door 2 and the reheat preventing door 3 is represented by δ, a force contributing to the drive of the reheat preventing door 3 is cos δ times as high as the force given to the end portion of the rotary door 2. Therefore, even when the angle (δ) formed between the rotary door 2 and the reheat preventing door 3 is extremely reduced as shown in FIG. 1, there is no possibility of a very high intensity of torque being required for the axial center portion of the rotary door 2. As a result, it is possible to reduce the angle (δ) formed between the protruding direction of the protruding portion 40 of the rotary door 2 and the extending direction of the reheat preventing door 3, and it becomes possible to reduce a space formed between the door portion 20 of the rotary door 2 and the reheat preventing door 3. For the above reasons, there is no possibility of a dead space, in which it is difficult for a conditioned air blast to flow, being formed. At this time, when the protruding portion 40 is provided as shown in the drawing, the cylindrical rotary door 2 and the flat reheat preventing door 3 can be made to come most closely to each other. Therefore, formation of a dead space can be most optimally suppressed.

In the air conditioner for vehicle use of this embodiment, the hinge portion for connecting the reheat preventing door with the rotary door may be composed as the following embodiments.

First Variation

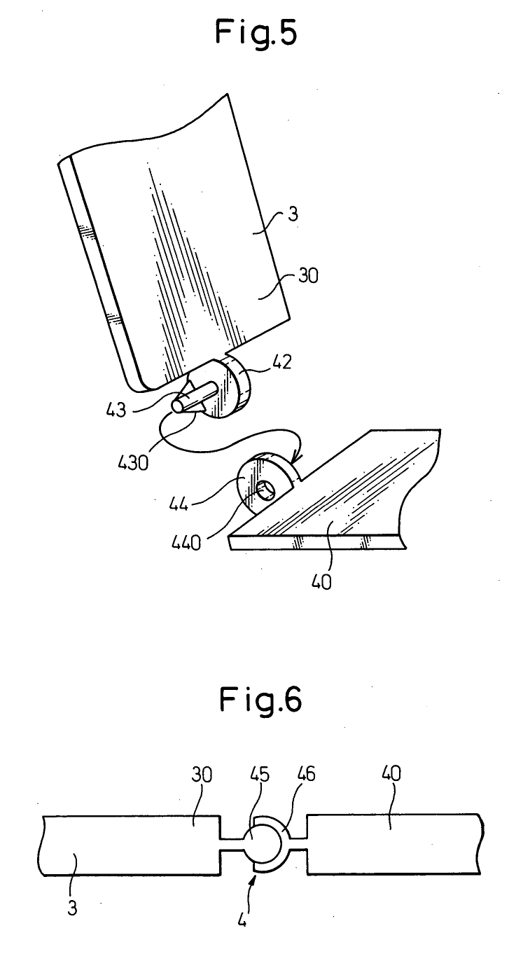

The hinge portion of this embodiment includes: a plate-shaped connecting base portion 42 which is protruded from the base end 30 of the reheat preventing door 3 being substantially perpendicular to the reheat preventing door 3; a substantially columnar connecting shaft portion 43 perpendicularly protruding from the connecting base end portion 42; and a bearing portion 44, which is provided at a forward end portion of the protruding portion 40, in which the through-hole 440 is open, wherein the connecting shaft portion 43 is pivotally inserted into the through-hole 440. At the forward end portion of the connecting shaft portion 43, the pawl portion 430, which prevents the connecting shaft portion 43 from coming out from the bearing portion 44 when the connecting shaft portion 43 penetrates the through-hole 440, protrudes. FIG. 5 is a view showing the structure of the hinge portion of this embodiment and the periphery thereof.

The hinge portion of this embodiment is composed in such a manner that the hinge portion connects the rotary door 2 with the reheat preventing door 3 and that the connecting shaft portion 43 is pivotally inserted into the through-hole 440 of the bearing portion 44.

When the hinge portion of this embodiment is manufactured, the rotary door and the reheat preventing door are respectively formed independently from each other and then assembled together. Therefore, it is easy to manufacture the hinge portion of this embodiment.

In the air conditioner for vehicle use having the hinge portion of this embodiment, in the same manner as that of the embodiment described before, the reheat preventing door is connected to the rotary door via the hinge portion. Therefore, the dead space formed between the door portion 20 of the rotary door 2 and the reheat preventing door 3 can be reduced, and generation of noise can be reduced.

Second Variation

The hinge portion of this embodiment includes: a ball portion 45 protruding from the base end 30 of the reheat preventing door 3; and a ball receiving portion 46 capable of pivotally receiving the ball portion 45. The structure of the hinge portion and the periphery thereof are shown in FIG. 6.

When the hinge portion of this embodiment is manufactured, the rotary door and the reheat preventing door are respectively formed independently from each other and then assembled together. Therefore, it is easy to manufacture the hinge portion of this embodiment.

In the air conditioner for vehicle use having the hinge portion of this embodiment, in the same manner as that of the embodiment described before, the reheat preventing door is connected to the rotary door via the hinge portion. Therefore, the dead space formed between the door portion 20 of the rotary door 2 and the reheat preventing door 3 can be reduced, and generation of noise can be reduced.

Third Variation

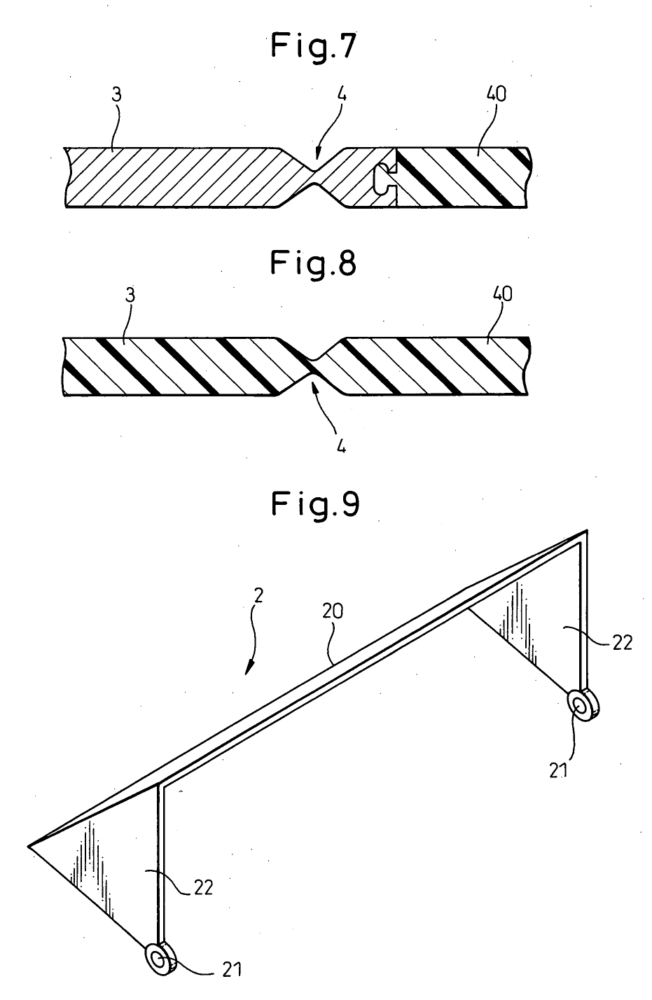

The hinge portion 4 of this embodiment is made of resin elastomer and formed being integrated with the reheat preventing door 3 into one body. In the same manner as that of the joint portion of the oscillating center portion 41 and the protruding portion 40 of the embodiment described before, the hinge portion 4 is formed by means of two color forming. The structure of the hinge portion of this embodiment and the periphery thereof are shown in FIG. 7.

The hinge portion 4 of this embodiment can be manufactured by means of two color forming so that the reheat preventing door 3 and the protruding portion 40 can be integrated with each other into one body.

In the air conditioner for vehicle use having the hinge portion of this embodiment, in the same manner as that of the embodiment described before, the reheat preventing door is connected to the rotary door via the hinge portion. Therefore, the dead space formed between the door portion 20 of the rotary door 2 and the reheat preventing door 3 can be reduced, and generation of noise can be reduced.

Fourth Variation

In this embodiment, the protruding portion 40 and the reheat preventing door 3 are made of resin elastomer and formed being integrated with each other into one body, and further the connecting portion has a thin-walled hinge portion 4. The thin-walled portion has a substantially V-shaped notch portion formed on both sides. The structure of the hinge portion of this embodiment and the periphery thereof are shown in FIG. 8.

In the hinge portion of this embodiment, the protruding portion 40 and the reheat preventing door 3 can be made of resin elastomer and formed being integrated with each other into one body.

In the air conditioner for vehicle use having the hinge portion of this embodiment, in the same manner as that of the embodiment described before, the reheat preventing door is connected to the rotary door via the hinge portion. Therefore, the dead space formed between the door portion 20 of the rotary door 2 and the reheat preventing door 3 can be reduced, and generation of noise can be reduced.

### Another Embodiment

In each embodiment described above, the reheat preventing door is connected to an end portion in the peripheral direction of the door portion of the rotary door. However, the door device of the present invention may comprise: a rotary door including an axial center portion held by a case composing an air passage, further including a support member integrally rotated with the axial center portion and furthermore including a door portion supported by the support member being connected to it, rotated together with the axial center portion while the door portion is drawing a circular locus concentrically with the axial center portion; and a driven door, one end of which is connected to the door portion being capable of oscillating, the other end of which slides along a guide groove provided in the case.

The reheat preventing door may be attached to a central portion in the peripheral direction of the door portion of the rotary door.

In each embodiment described above, the door portion of the rotary door is formed into a substantially cylindrical shape. However, the door portion of the rotary door may be formed into a flat plate shape. The rotary door formed into a flat plate shape is shown in FIG. 9.

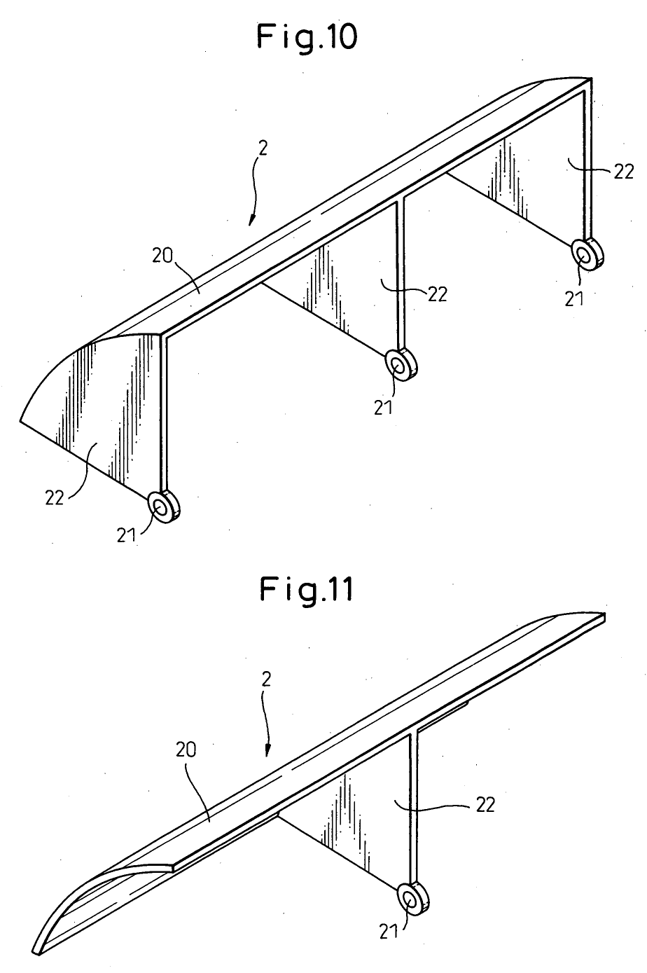

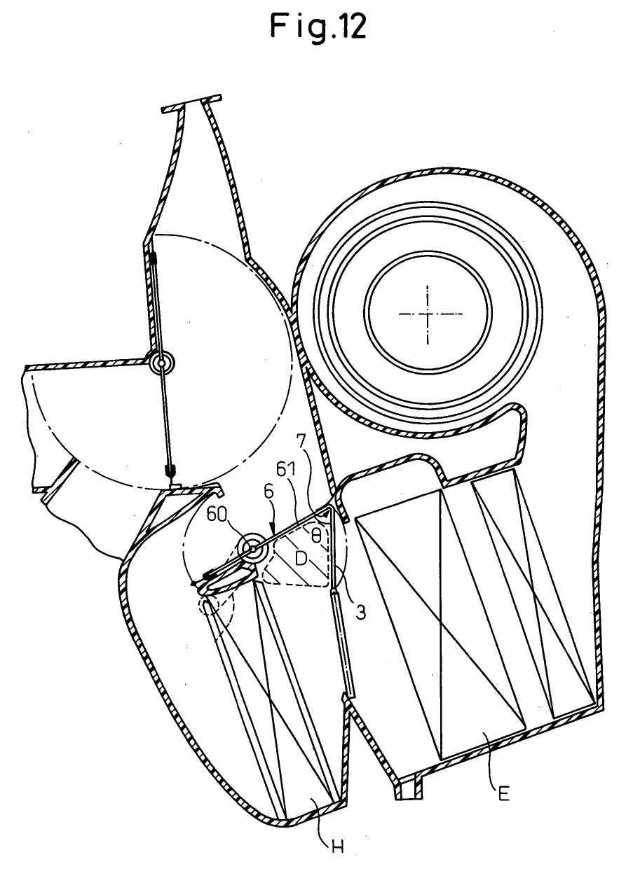

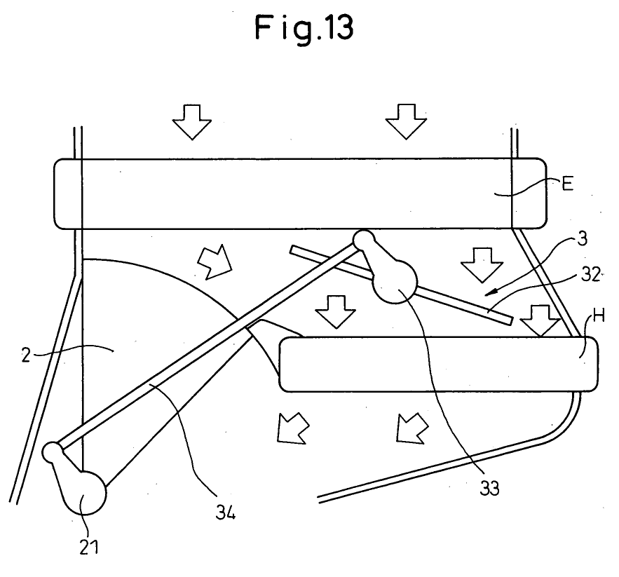

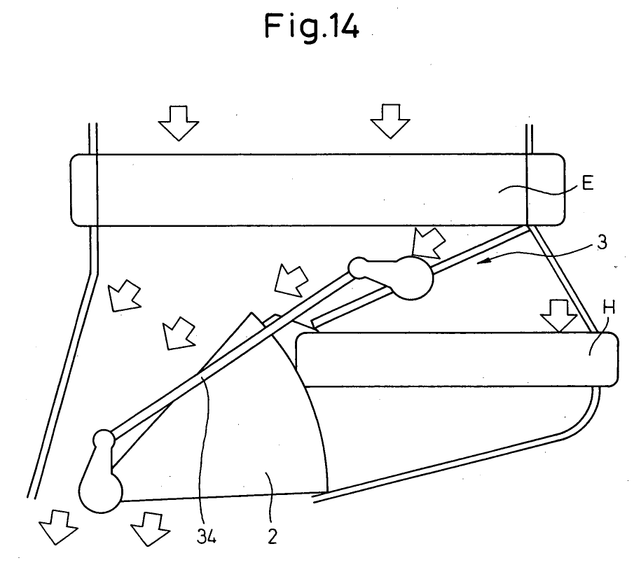

In each embodiment described above, the door portion of the rotary door is supported by the support portion at both end portions in the axial direction. However, the support portion may be provided in portions except for both end portions. For example, further a plate-shaped support portion may be arranged at the central portion in the axial direction of the rotary door of the above embodiment as shown in FIG. 10.

In each embodiment described above, the door portion of the rotary door is supported by the support portion at both end portions in the axial direction. However, the support portion may be provided in portions except for both end portions. For example, a plate-shaped support portion may be arranged only at the central portion in the axial direction of the rotary door of the above embodiment as shown in FIG. 11.

### Still Another Embodiment

In the air conditioner for vehicle use described above, the door portion 20 of the rotary door 2 is displaced on the downstream side of heater core H, and the reheat preventing door 3 is displaced on the upstream side of heater core H. However, the air conditioner for vehicle use may be composed in such a manner that the door portion 20 of the rotary door 2 is displaced on the upstream side of heater core H, and the reheat preventing door 3 is displaced on the downstream side of heater core H. In the air conditioner for vehicle use composed as described above, the reheat preventing door is connected to the rotary door via the hinge portion. Therefore, the dead space formed between the door portion of the rotary door and the reheat preventing door can be reduced, and generation of noise can be reduced.

In each embodiment described above, the rotary door and the driven door are used as the air mixing door and the reheat preventing door. However, the rotary door and the driven door may be used as doors for changing over an air passage of another portion of the air conditioner for vehicle use. In this case, the size of the protruding portion 40 can be minimized and the size of the dead space can be further minimized. On the other hand, even when the door face of the rotary door 2 is formed into a shape such as a free curved face, the above effect can be provided as long as the door face of the reheat preventing door is formed into the shape along the door face of the rotary door.

When the air conditioner for vehicle use of still another embodiment is composed in the same manner as that of the first to the fourth variation and another embodiment, the same effect can be provided.

The air conditioner for vehicle use of the present invention includes an air conditioning case, a heat exchanger for heating, a rotary door and a reheat preventing door.

The air conditioning case composes an air passage. In the air passage composed in the air conditioning case, a blast of air not heated or cooled or a blast of the conditioned air flows.

The heat exchanger for heating is arranged in the air passage. The heat exchanger for heating heats air flowing in the air passage. An example of the heat exchanger for heating is a heater core.

The rotary door includes: an axial center portion rotating round the rotary center; a door portion which is arranged at a position distant from the axial center portion by a predetermined distance and displaced in the circumferential direction in accordance with the rotation of the axial center portion; and a support portion for connecting the axial center portion with the door portion. On one of the upstream side and the downstream side of the heat exchanger for heating, the rotary door is displaced between a position, at which the heat exchanger for heating is completely opened, and a position at which the heat exchanger for heating is completely closed. When the rotary door is displaced between the position, at which the heat exchanger for heating is completely opened, and the position at which the heat exchanger for heating is completely closed, the flow rate of air flowing in the heat exchanger for heating is controlled. When the rotary door is rotated round the rotary center, the door portion is displaced in the circumferential direction in accordance with the rotation of the rotary door, and air flowing in a portion where the rotary door is arranged is obstructed by the door portion. When the door portion obstructs the flow of air as described above, the volume of air passing through the heat exchanger for heating is changed. After that, the air, which has passed through the heat exchanger for heating, and the air, which has made a detour round the heat exchanger for heating, are mixed with each other, so that the temperature of the conditioned air can be adjusted.

The reheat preventing door is connected to the rotary door via the hinge portion so that the reheat preventing door can be located outside in the radial direction of the door portion. The reheat preventing door is displaced according to the rotation of the rotary door. On one of the upstream side and the downstream side of the heat exchanger for heating, the reheat preventing door is displaced between the position where the heat exchanger for heating is completely opened and the position where the heat exchanger for heating is completely closed. In this case, the radial direction, in which the reheat preventing door is located, is a direction directed from the rotary shaft of the rotary door to the door portion. The outside in the radial direction is a position where the reheat preventing door is distant from the door portion in the radial direction. By way of the hinge portion, the heat preventing door is pivotally connected to the rotary door. The hinge portion is connected to the rotary door. Therefore, when the rotary door is rotated, the hinge portion is also displaced in the circumferential direction. The reheat preventing door is connected to the hinge portion. Therefore, when the hinge portion is displaced, the reheat preventing door is also displaced, and the reheat preventing door is displaced on one of the upstream side and the downstream side of the heat exchanger for heating. When the reheat preventing door is displaced between the position where the heat exchanger for heating is completely opened and the position where the heat exchanger for heating is completely closed, the flow rate of air flowing in the heat exchanger for heating is adjusted. That is, a force for rotating the rotary door is exerted on the reheat preventing door via the hinge portion. By this force, the reheat preventing door is displaced. In this case, since the reheat preventing door is connected to the rotary door via the hinge portion so that the reheat preventing door can be oscillated round the hinge portion, the direction of the displacement of the reheat preventing door is not limited to the circumferential direction.

In the air conditioner for vehicle use of the present invention, the reheat preventing door is displaced by the rotation of the rotary door, and at least a portion of the air flowing in the heat exchanger for heating is obstructed by the reheat preventing door. In the conventional air conditioner for vehicle use described in the French Patent Document described before, the rotary angle of the rotary shaft is determined by the angle θ formed between the line connecting the rotary shaft with the hinge (the direction in which the air mixing door is extending) and the reheat preventing door. Therefore, when the angle θ is small, the rotary angle is large, and when the angle θ is large, the rotary angle is small. Further, it is conventional that a large dead space is formed between the air mixing door and the reheat preventing door so that the rotary angle can be somewhat reduced. On the other hand, in the air conditioner for vehicle use of the present invention, the door portion and the axial center portion are arranged via the support portion being separate from each other, and the reheat preventing door is connected to the door portion via the hinge portion. Since the door portion and the axial center portion are arranged being separate from each other, the reheat preventing door and the door portion of the rotary door come close to each other irrespective of the rotary angle of the axial center portion of the rotary door.

Therefore, the dead space formed between the reheat preventing door and the door portion of the rotary door can be reduced. Accordingly, in the air conditioner for vehicle use of the present invention, since the dead space formed between the reheat preventing door and the door portion of the rotary door can be reduced, generation of noise can be decreased.

It is preferable that the reheat preventing door is connected to an end portion in the circumferential direction of the rotary door. When the reheat preventing door is connected to the end portion in the circumferential direction of the rotary door, the air flowing in the air passage is not obstructed beyond necessity. If the reheat preventing door is connected to a portion except for the end portion in the circumferential direction of the rotary door, the rotation of the rotary door is regulated by the hinge portion, and a portion of the door portion obstructs an air flow in the air passage at all times. Therefore, it is preferable that the end portion in the circumferential direction of the rotary door connected with the reheat preventing door is an end portion of the door portion.

It is preferable that the hinge portion includes a protruding portion protruding from the rotary door and an oscillating center portion provided at a forward end of the protruding portion. Since the hinge portion includes the protruding portion, the oscillating center portion is located at a position distant from rotary door. Therefore, the dead space formed between the reheat preventing door and the door portion of the rotary door can be reduced.

It is preferable that the reheat preventing door has a guide protruding portion protruding from the end portion in the axial direction of the axial center portion and that the air conditioning case has a guide groove into which a forward end portion of the guide protruding portion is inserted so that the displacement of the reheat preventing door can be guided by the guide groove. When the reheat preventing door has the guide protruding portion and the guide groove is formed in the air conditioning case, the reheat preventing door cat be displaced along the guide groove. Therefore, the rotary angle of the rotary door and the displacement of the reheat preventing door are correlated with each other. Accordingly, the volume of air flowing in the air passage to be obstructed by the reheat preventing door can be determined by the rotary angle of the rotary door.

It is preferable that the support portion is formed in a plate-shape extending in the air flowing direction. When the support portion is formed in a plate-shape, the support portion arranged in the air passage does not obstruct an air flow in the air passage.

In the air conditioner for vehicle use of the present invention, on one of the upstream side and the downstream side of the heat exchanger for heating, the door portion of the rotary door is displaced between the position where the heat exchanger for heating is completely opened and the position where the heat exchanger for heating is completely closed, and on the other of the upstream side and the downstream side of the heat exchanger for heating, the reheat preventing door is displaced between the position where the heat exchanger for heating is completely opened and the position where the heat exchanger for heating is completely closed. That is, in the air conditioner for vehicle use of the present invention, as long as the heat exchanger for heating is arranged between the door portion of the rotary door and the reheat preventing door, the rotary door may be arranged either on the upstream side or on the downstream side. In the air conditioner for vehicle use of the present invention, it is preferable that the rotary door is displaced on the upstream side of the heat exchanger for heating and that the reheat preventing door is displaced on the downstream side of the heat exchanger for heating. In the air conditioner for vehicle use of the present invention, it is preferable that the rotary door is displaced on the downstream side of the heat exchanger for heating and that the reheat preventing door is displaced on the upstream side of the heat exchanger for heating.

An air conditioner for vehicle use of the present invention comprises: an air conditioning case for forming an air passage; an evaporator arranged in the air passage; a heat exchanger for heating arranged in the air passage on the downstream side of the evaporator; a reheat preventing door arranged in the air passage between the evaporator and the heat exchanger for heating, for partitioning the air passage; and a rotary door arranged in the air passage, for adjusting the ratio of a volume of air sent from the evaporator and making a detour round the heat exchanger for heating to a volume of air passing in the heat exchanger for heating, wherein a door portion of the rotary door is formed into a substantially arcuate shape swelling toward the upstream side of the air passage.

That is, in the air conditioner for vehicle use of the present invention, air introduced into the air conditioning case is cooled by the evaporator and made to be a cold air blast. The cold air blast is heated by the heat exchanger for heating arranged in the downstream of the evaporator. The cold air blast can also flow while making a detour round the heat exchanger for heating. Then, the hot air blast heated by the heat exchanger for heating and the cold air blast making a detour round the heat exchanger for heating are mixed with each other and made to be a blast of conditioned air and blown out into a vehicle interior. The ratio of the hot air blast to the cold air blast contained in the conditioned air is adjusted by the rotary door arranged in the air passage. In the air conditioner for vehicle use of the present invention, in order to prevent the cold air blast making a detour round the heat exchanger for heating from being heated when it flows in the periphery of the heat exchanger for heating, the reheat preventing door is provided. By the action of the reheat preventing door, the temperature of the cold air blast making a detour round the heat exchanger for heating can be maintained low. Therefore, the temperature of the blast of conditioned air blown out from the air conditioner for vehicle use can be controlled. In the air conditioner for vehicle use of the present invention, when the rotary door is rotated by the rotary shaft arranged in the central axis portion of the arcuate face of the door portion, the ratio of the hot air blast to the cold air blast can be adjusted.

In the air conditioner for vehicle use of the present invention, the reheat preventing door is arranged so that the reheat preventing door can be reciprocated in the direction inclined with respect to the direction of air flowing in the air passage, and the end portion of the reheat preventing door is connected via the hinge portion to the periphery of the end portion, which is distant from the heat exchanger for heating, in the circumferential direction of the door portion of the rotary door.

When the reheat preventing door is reciprocated in the direction inclined with respect to the direction of air flowing in the air passage, the degree of opening of the air passage is adjusted. When the reheat preventing door is slid in the direction inclined in the air flowing direction and the degree of opening of the air passage is decreased, the flow rate of the cold air blast proceeding to the heat exchanger for heating is decreased and the cold air blast can be prevented from being reheated. When the reheat preventing door is reciprocated, the flow rate of the cold air blast can be controlled.

When the reheat preventing door is connected to the end portion of the rotary door, the reheat preventing door is reciprocated in the air passage according to the rotation of the rotary door. Specifically, the reheat preventing door is connected to the periphery of the end portion, which is distant from the heat exchanger for heating, in the circumferential direction of the rotary door. When the rotary shaft of the rotary door is rotated, the door portion is rotated in the circumferential direction, and the degree of opening of the bypass passage, in which the cold air blast making a detour round the heat exchanger for heating flows, and the degree of opening of the air passage on the downstream side of the heat exchanger for heating are changed. Due to the foregoing, the ratio of mixing the hot air blast with the cold air blast is controlled. In this case, when the degree of opening of the bypass passage is maximized, the end portion, which is the end portion in the circumferential direction of the door portion and distant from the heat exchanger for heating, comes close to the heat exchanger for heating. When the degree of opening of the bypass passage is minimized, the end portion, which is the end portion in the circumferential direction of the door portion and distant from the heat exchanger for heating, is separated from the heat exchanger for heating. Therefore, when the reheat preventing door is connected to this end portion, the opening of the air passage to the heat exchanger for heating can be controlled according to the opening of the bypass passage.

Since the reheat preventing door is connected to the rotary door via the hinge portion, even when the end portion of the rotary door is displaced in the circumferential direction, the reheat preventing door can be reciprocated by changing the angle, which is formed between the rotary door and the reheat preventing door, by the action of the hinge portion.

It is preferable that the hinge portion of the reheat preventing door is connected to the protruding portion protruding outward in the radial direction from the door face of the rotary door. When the reheat preventing door is connected to the door face of the rotary door via the protruding portion, the back face of the reheat preventing door and the door face of the rotary door are separate from each other while leaving an interval. Due to the foregoing, the back face of the reheat preventing door and the door face of the rotary door are not contacted with each other. Therefore, movements of the back face of the reheat preventing door and the door face of the rotary door are not restricted from each other. As a result, it is possible to move the reheat preventing door and the rotary door without exerting an excessively strong force to them.

The hinge portion for connecting the reheat preventing door with the rotary door is not particularly limited to the above specific embodiment, as long as the hinge portion can freely change an angle formed between the back face of the reheat preventing door and the door face of the rotary door.

It is preferable that the air conditioning case includes a guide groove for guiding a reciprocating motion of the reheat preventing door and that the reheat preventing door includes a protruding portion which is formed at the forward end portion and inserted into and guided by the guide groove. Since the guide groove and the guide protruding portion are provided as described above, the guide protruding portion formed at the forward end portion of the reheat preventing door is guided by the guide groove and displaced along the guide groove. Accordingly, the forward end portion of the reheat preventing door is displaced in the direction in which the guide groove extends.

The structure of the air conditioner for vehicle use of the present invention can be the same as that of the conventional well known air conditioner for vehicle use, except that the reheat preventing door is connected to the rotary door via the hinge portion.

The door device of the present invention includes a rotary door and a driven door.

The rotary door includes: a rotary shaft held by a case composing a passage; a support member rotated integrally with the rotary shaft; and a door portion connected to and supported by the support member and rotated on a circular locus concentrically with the axial center portion when the axial center portion is rotated.

Concerning the driven door, one end portion of the driven door is connected to the door portion being capable of oscillating, and the other end portion slides along the sliding portion provided in the case.

In the door device of the present invention, when the rotary door is rotated round the axial center portion, the support member, which is connected to the axial center portion, and the door portion are rotated round the axial center. When the door portion is rotated as described above, the degree of opening of the passage, in which the rotary door is held, is adjusted, so that the flow rate of the fluid flowing in the passage can be controlled.

When the axial center portion of the rotary door is rotated, the driven door is slid along the sliding portion provided in the case. This driven door also adjusts the degree of opening of the passage so that a flow rate of the fluid flowing in the passage can be controlled. Since the driven door is oscillatably connected to the door portion of the rotary door, the driven door is slid when the rotary door is displaced. The driven door and the door portion of the rotary door can adjust the volume of the circulating fluid at different positions of the passage in the case.

It is preferable that the door device of the present invention is used for changing over the air passage of the air conditioner for vehicle use as described above.

While the invention has been described by reference to specific embodiments chosen for purposes of illustration, it should be apparent that numerous modifications could be made thereto by those skilled in the art without departing from the basic concept and scope of the invention.

1. An air conditioner for vehicle use comprising:
an air conditioning case for forming an air passage;
a heat exchanger for heating arranged in the air passage;
a rotary door including an axial center portion rotating round a rotary center, further including a door portion arranged at a position distant from the axial center by a distance and displaced in the circumferential direction according to the rotation of the axial center, furthermore including a support portion for connecting the axial center with the door portion, wherein the door portion is displaced between a position, at which the door portion completely closes the heat exchanger for heating at the time of MAX COOL, and a position, at which the door portion completely opens the heat exchanger for heating at the time of MAX HOT, on one of the upstream side and the downstream side of the heat exchanger for heating, and
a reheat preventing door connected to the rotary door via a hinge portion so that the reheat preventing door can be located outside the door portion in the radial direction, displaced according to the rotation of the rotary door, wherein
the reheat preventing door is displaced between a position, at which the reheat preventing door completely closes the heat exchanger for heating at the time of MAX COOL, and a position, at which the reheat preventing door completely opens the heat exchanger for heating at the time of MAX HOT, on the other of the upstream side and the downstream side of the heat exchanger for heating.

2. An air conditioner for vehicle use according to claim 1, wherein the reheat preventing door is connected to an end portion in the circumferential direction of the rotary door.

3. An air conditioner for vehicle use according to claim 1, wherein the hinge portion includes a protruding portion protruding from the rotary door and an oscillating center portion provided at a forward end of the protruding portion.

4. An air conditioner for vehicle use according to claim 1, wherein the reheat preventing door has a guide protruding portion protruding from an end portion in the axial direction of the axial center portion, and the air conditioning case has a guide groove into which the forward end portion of the guide protruding portion is inserted so that a displacement of the reheat preventing door can be guided by the guide groove.

5. An air conditioner for vehicle use according to claim 1, wherein the support portion is formed in a plate-shape extending in the air flowing direction.

6. An air conditioner for vehicle use comprising:
an air conditioning case for forming an air passage;
an evaporator arranged in the air passage;
a heat exchanger for heating arranged in the air passage on the downstream side of the evaporator;
a reheat preventing door arranged in the air passage between the evaporator and the heat exchanger for heating, for partitioning the air passage; and
a rotary door arranged in the air passage, for adjusting the ratio of a volume of air sent from the evaporator and making a detour round the heat exchanger for heating to a volume of air passing in the heat exchanger for heating, a door portion of the rotary door being formed in a substantially arcuate shape swelling toward the upstream side of the air passage, wherein
the reheat preventing door is arranged so that it can be reciprocated in a direction oblique to the flow direction of air flowing in the air passage, and
an end portion of the reheat preventing door is connected to a portion close to an end portion in the circumferential direction of the door portion of the rotary door, the end portion being distant from the heat exchanger for heating, by the hinge portion.

7. An air conditioner for vehicle use according to claim 6, wherein the hinge portion of the reheat preventing door is connected to a protruding portion protruding outside in the radial direction from the door face of the rotary door.

8. An air conditioner for vehicle use according to claim 6, wherein the air conditioning case has a guide groove for guiding a reciprocating movement of the reheat preventing door, and the reheat preventing door has a guide protrusion at its forward end portion which is inserted into and guided by the guide groove.

9. A door device comprising:
a rotary door including an axial center portion held by a case composing an air passage, further including a support member integrally rotated with the axial center portion and furthermore including a door portion supported by the support member being connected to it, rotated together with the axial center portion while the door portion is drawing a circular locus concentrically with the axial center portion; and
a driven door, one end of which is connected to the door portion being capable of oscillating, the other end of which slides along a sliding portion provided in the case.
